(19) United States
(12) Patent Application Publication
(10) Pub. No.: US 2008/0122782 A1
(43) Pub. Date: May 29, 2008

(54) Liquid crystal display device with red, green, and blue light emitting diodes connected in series

(75) Inventor: Xiao-Jing Qi, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/998,029

(22) Filed: Nov. 27, 2007

(30) Foreign Application Priority Data
Nov. 27, 2006 (TW) 95143795

(51) Int. Cl. G09G 3/36

(52) U.S. Cl. 345/102

(57) ABSTRACT

An exemplary liquid crystal display device includes a liquid crystal display panel and a backlight module. The backlight module includes a driving circuit and a light emitting diode array. The driving circuit includes a first terminal, and the light emitting diode array includes a plurality of red, green, and blue light emitting diodes connected in series. A number of the red light emitting diodes is “a”, and a number of the green light emitting diodes is “b”. Further, a number of the blue light emitting diodes is “c”. Numbers of “a”, “b”, and “c” are determined according to a predetermined color coordinate of the liquid crystal panel. The driving circuit drives the red, green, and blue light emitting diodes via the first terminal, to enable the red, green, and blue light emitting diodes to emit light beams for illuminating the liquid crystal display panel.

### FIELD OF THE INVENTION

The present invention relates to liquid crystal displays (LCDs), and more particularly to an LCD device having a backlight module with red, green, and blue light emitting diodes connected in series.

### BACKGROUND

Because LCD devices have the advantages of portability, low power consumption, and low radiation, they have been widely used in various portable information products such as notebooks, personal digital assistants (PDAs), video cameras, and the like. A typical LCD device includes an LCD panel and a backlight module for illuminating the LCD panel.

The backlight module usually uses cold cathode fluorescent lamps (CCFLs) or light emitting diodes (LEDs) as light sources for emitting light beams, whereby the light source composed of red, green, blue LEDs has a high color saturation.

Referring to FIG. 5, this is a schematic, side cross-sectional view of a conventional LCD device 1. The LCD device 1 includes an LCD panel 10 and a backlight module 11. The backlight module 11 is disposed under the LCD panel 10 and provides light beams to illuminate the LCD panel 10.

The LCD panel 10 includes a first substrate 100, a second substrate 120 disposed parallel to and spaced apart from the first substrate 100, and a liquid crystal layer 110 interposed between the first and second substrates 100, 120. The first substrate 100 includes a color filter 130 disposed at an inner surface thereof, adjacent to the liquid crystal layer 110. The color filter layer 130 includes a plurality of red color filter units 131, a plurality of green color filter units 132, and a plurality of blue color filter units 133. The red, green, and blue color filter units 131, 132, 133 are used to display colored images.

Also referring to FIG. 6, the backlight module 11 includes a driving circuit 111 and an LED array 112. The driving circuit 111 includes a first terminal 113, a second terminal 114, and a third terminal 115. The LED array 112 includes a plurality red LEDs 116 electrically connected to the first terminal 113 in series, a plurality of green LEDs 117 electrically connected to the second terminal 114 in series, and a plurality of blue LEDs 118 electrically connected to the third terminal 115 in series. The number of the red, green, and blue LEDs is the same.

Because the red, green, and blue LEDs 116, 117, 118 have different spectrums, different driving voltages are respectively provided to the red, green, and blue LEDs 116, 117, 118 via the first, second, and third terminals 113, 114, 115, to control the LEDs 116, 117, 118 to emit light beams with different intensity. Thereby, the mixed red, green, and blue light beams may generate white light beams with a certain spectrum.

However, the backlight module 11 needs three terminals 113, 114, 115 to provide driving voltages to the red, green, and blue LEDs, 116, 117, 118, respectively, which makes the structure of the backlight module 11 unduly complicated.

It is desired to provide an LCD device which can overcome the above-described deficiencies.

### SUMMARY

An exemplary liquid crystal display device includes a liquid crystal display panel and a backlight module. The backlight module includes a driving circuit and a light emitting diode array. The driving circuit includes a first terminal, and the light emitting diode array includes a plurality of red, green, and blue light emitting diodes connected in series. A number of the red light emitting diodes is “a”, and a number of the green light emitting diodes is “b”. Further, a number of the blue light emitting diodes is “c”. Numbers of “a”, “b”, and “c” are determined according to a predetermined color coordinate of the liquid crystal panel. The driving circuit drives the red, green, and blue light emitting diodes via the first terminal, to enable the red, green, and blue light emitting diodes to emit light beams for illuminating the liquid crystal display panel.

Other novel features and advantages of the present driving method will become more apparent from the following detailed description when taken in conjunction with the accompanying drawings, in which:

### BRIEF DESCRIPTION OF THE DRAWINGS

FIG. 1 is a schematic, side cross-sectional view of an LCD device according to an exemplary first embodiment of the present invention;

FIG. 2 is a circuit diagram of a backlight module installed in the LCD device of FIG. 1;

FIG. 3 shows a 1391CIE-XY chromaticity system diagram announced by the International Commission on Illumination (CIE);

FIG. 4 is a circuit diagram of a backlight module installed in an LCD device according to an exemplary second embodiment of the present invention;

FIG. 5 is a schematic, side cross-sectional view of a conventional LCD device; and

FIG. 6 is a circuit diagram of a backlight module installed in the LCD of FIG. 5.

### DETAILED DESCRIPTION OF PREFERRED EMBODIMENTS

Reference will now be made to the drawings to describe preferred and exemplary embodiments of the present invention in detail.

FIG. 1 is a schematic, side cross-sectional view of an LCD device according to an exemplary first embodiment of the present invention. The LCD device 2 includes an LCD panel 20 and a backlight module 21. The backlight module 21 is disposed adjacent to the LCD panel 20 for illuminating the LCD panel 20.

The LCD panel 20 includes a first substrate 200, a second substrate 220 disposed parallel to and spaced apart from the first substrate 200, and a liquid crystal layer 210 interposed between the first and second substrates 200, 220.

The first substrate 200 includes a first polarizer 290 disposed at an outer surface thereof, and a color filter 230, a common electrode 240, and a first alignment film 250 disposed at an inner surface thereof from top to bottom in that order. The color filter 230 includes a plurality of red color filter units 231, a plurality of green color filter units 232, and a plurality of blue color filter units 233. The red, green, and blue color filter units 231, 232, 233 are regularly and alternatively arranged.

The second substrate 220 includes a second polarizer 219 disposed at an outer surface thereof, and a pixel electrode layer 221 and a second alignment film 222 disposed at an inner surface thereof from bottom to top in that order. The liquid crystal layer 210 is disposed between the first and second alignment films 250, 222.

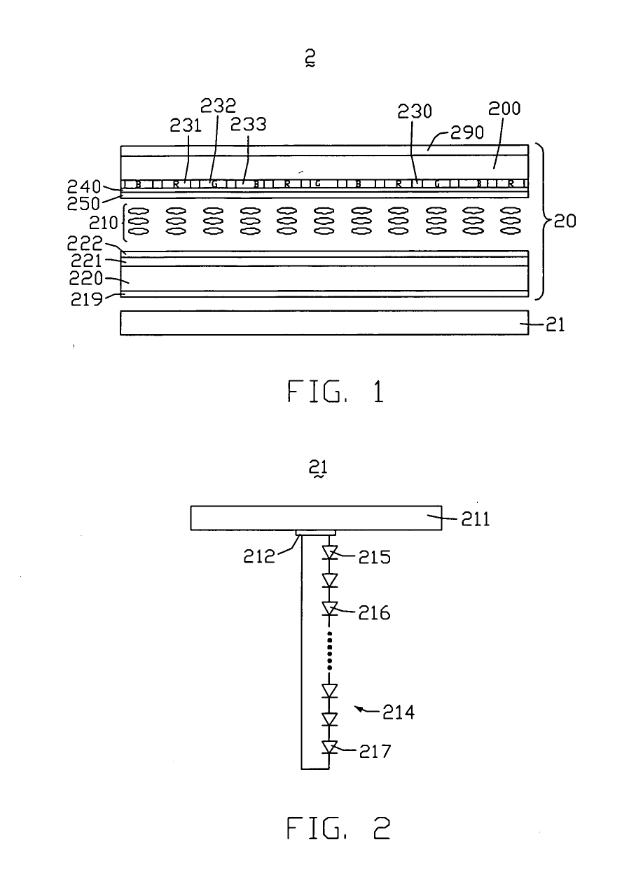

Also referring to FIG. 2, the backlight module 21 includes a driving circuit 211 and an LED array 214. The driving circuit 211 includes a first terminal 212 for providing driving voltages to the LED array 214. The LED array 214 includes a plurality red LEDs 215, a plurality of green LEDs 216, and a plurality of blue LEDs 217 electrically connected to the first terminal 215 in series. A number of the red light emitting diodes is “a”, a number of the green light emitting diodes is “b”, and a number of the blue light emitting diodes is “c”.

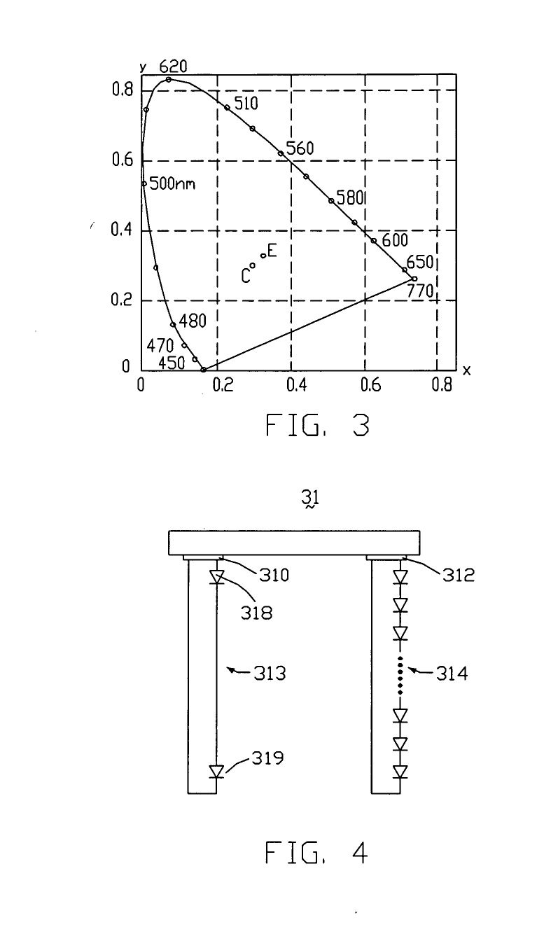

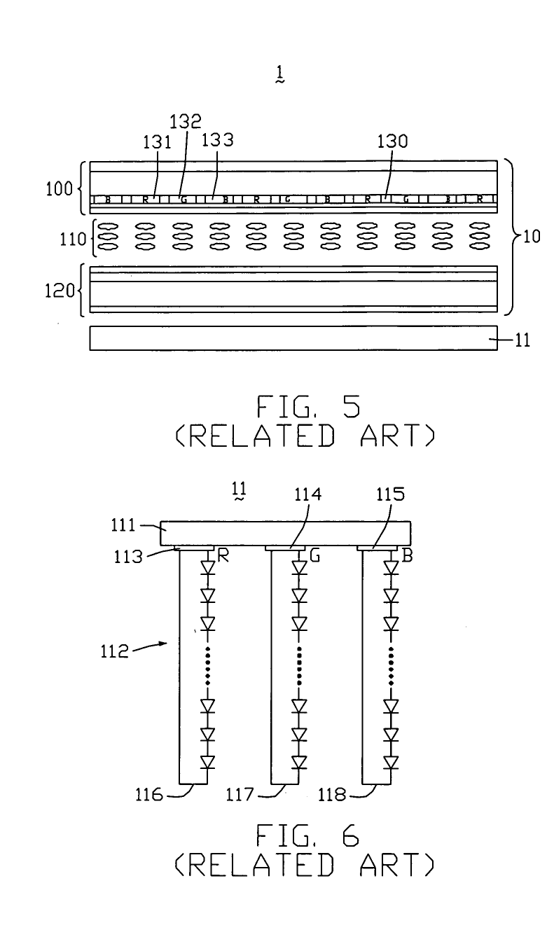

Also referring to FIG. 3, a 1391CIE-XY chromaticity system diagram announced by the International Commission on Illumination (CIE) is shown. In this diagram, a wavelength of either a visible light can be determined by a unique chromaticity coordinate of the chromaticity system. The “a” red LEDs 215, “b” green LEDs 216, and “c” blue LEDs 217 cooperatively make the backlight module 21 to output light beams with pre-determined wavelength, so as to enable the light beams with pre-determined wavelength cooperative with the LCD panel 20 to display red, green, blue, and other images.

Before illustrating how to setting the numbers “a”, “b”, and “c” of the red, green, and blue LEDs 215, 216, 217, the basic theory of the 1391CIE-XYZ chromaticity system is described as below.

Either a color value can be expressed by the following equation:

C=X[X]+Y[Y]+Z[Z]

where C represents a color value, [X], [Y], and [Z] respectively represent unitages of tri-chrominance primary, and X, Y, and Z represent tristimulus values, thereby the tristimulus values can be expressed by the following equation:

$$\{ \begin{matrix}X = k \sum S ( λ ) τ ( λ ) \overline{x} ( λ ) Δ λ \\ Y = k \sum S ( λ ) τ ( λ ) \overline{y} ( λ ) Δ λ \\ Z = k \sum S ( λ ) τ ( λ ) \overline{z} ( λ ) Δ λ\end{matrix} \\ τ ( λ ) = {Πτ}_{i} ( λ ) \qquad ( 1 )$$

where x̅(λ), y̅(λ), and z̅(λ) represent spectral tristimulus values, S(λ) represents light source spectrum, and τ(λ) represents penetration spectrum, k is a parameter, λ represents wavelength.

The chromaticity coordinates of the 1931CIE-XYZ chromaticity system may be expressed by the following equation:

$$x = \frac{X}{X + Y + Z} , y = \frac{Y}{X + Y + Z} \qquad ( 2 )$$

The steps for setting the numbers “a”, “b”, and “c” of the red, green, and blue LEDs 215, 216, 217 are described as below.

The first step is to obtain the parameters. The light source spectrums S(R), S(G), and S(B) are obtained by detecting the spectrum under the condition of respectively providing the same driving voltage to a single red, a single green, and a single blue LEDs 215, 216, 217; the first polarizer 290 has a penetration spectrum of τ₂(λ); the second polarizer 219 has a penetration spectrum of τ₃(λ); the pixel electrode layer 221 has a penetration spectrum of τ₄(λ); the common electrode 240 has a penetration spectrum of τ₅(λ), the first alignment film 250 has a penetration spectrum of τ₆(λ); the second alignment film 222 has a penetration spectrum of τ₇(λ); each of the red color filter units 231 has a penetration spectrum of τ_{1R}(λ); each of the green color filter units 232 has a penetration spectrum of τ_{1G}(λ); and each of the blue color filter units 233 has a penetration spectrum of τ_{1B}(λ).

Secondly, calculating the tristimulus values of the LCD device 2 displaying red, green, and blue images via respectively using a single red LED 215, a single green LED 216, or a single blue LED 217 as the light source for outputting light beams.

It takes a single red LED 215 as an example to illustrate the calculating process. A single red LED 215 is taken as the light source to illuminate the LCD device 2, whereby the light beams emitted by the red LED 215 respectively pass through the color filter units 231, 232, 233, to make the LCD device 2 to display pre-determined red, green, and blue images. Then calculating the tristimulus values according to the equation (1) described above. Respectively calculate the tristimulus values via taking a single green LED 216 or a single blue LED 217 as the light source, i.e., calculating the variables of the following table:

| | Tristimulus values | | | | | | | | |
|---|---|---|---|---|---|---|---|---|---|
| light | displaying red | | | displaying green | | | displaying blue | | |
| source | X | Y | Z | X | Y | Z | X | Y | Z |
| a red | X1R | Y1R | Z1R | X1G | Y1G | Z1G | X1B | Y1B | Z1B |
| LED | | | | | | | | | |
| a green | X2R | Y2R | Z2R | X2G | Y2G | Z2G | X2B | Y2B | Z2B |
| LED | | | | | | | | | |
| a blue | X3R | Y3R | Z3R | X3G | Y3G | Z3G | X3B | Y3B | Z3B |
| LED | | | | | | | | | |

Thirdly, calculating the tristimulus values of the LCD device 2 displaying red, green, and blue images via using the LED array 214 with a plurality of red, green, and blue LEDs 215, 216, 217 as the light source for outputting light beams, according to the principle of superposition.

According to the Grassman theory, the visual response of eyes of the user is determined by the algebraic sum of the weights of the red, green, and blue light beams. That is, the proportion of weights of the red, green, and blue light beams determines the color of visual sense. Then, setting a number of the red light emitting diodes is “a”, and a number of the green light emitting diodes is “b”. Further, a number of the blue light emitting diodes is “c”. Thereby, calculating the tristimulus values of the LCD device 2 displaying red, green, and blue images via using the LED array 214 with “a” red LEDs 215, “b” green LEDs 216, and “c” blue LEDs 217 as the light source, according to the principle of superposition, i.e., calculating the variables of the following table:

| | tristimulus values | | | | | | | | |
|---|---|---|---|---|---|---|---|---|---|
| light | displaying red | | | displaying green | | | display blue | | |
| source | X | Y | Z | X | Y | Z | X | Y | Z |
| a | XRR | YRR | ZRR | XGR | YGG | ZGB | XBR | YBG | ZBB |
| plurality | | | | | | | | | |
| of | | | | | | | | | |
| LEDs | | | | | | | | | |

whereby the variables can be expressed by the matrix of:

$$XRR = ( a , b , c ) \cdot [ \begin{matrix}X 1 R \\ X 2 R \\ X 3 R\end{matrix} ] XGR = ( a , b , c ) \cdot [ \begin{matrix}X 1 G \\ X 2 G \\ X 3 G\end{matrix} ] \\ XBR = ( a , b , c ) \cdot [ \begin{matrix}X 1 B \\ X 2 B \\ X 3 B\end{matrix} ] YRG = ( a , b , c ) \cdot [ \begin{matrix}Y 1 R \\ Y 2 R \\ Y 3 R\end{matrix} ] \\ YGG = ( a , b , c ) \cdot [ \begin{matrix}Y 1 G \\ Y 2 G \\ Y 3 G\end{matrix} ] YBG = ( a , b , c ) \cdot [ \begin{matrix}Y 1 B \\ Y 2 B \\ Y 3 B\end{matrix} ] \\ ZRB = ( a , b , c ) \cdot [ \begin{matrix}Z 1 R \\ Z 2 R \\ Z 3 R\end{matrix} ] ZGB = ( a , b , c ) \cdot [ \begin{matrix}Z 1 G \\ Z 2 G \\ Z 3 G\end{matrix} ] \\ ZBB = ( a , b , c ) \cdot [ \begin{matrix}Z 1 B \\ Z 2 B \\ Z 3 B\end{matrix} ] \qquad ( 3 )$$

where the calculating result is an equation including the variable of “a”, “b”, and “c”.

The fourth step is to convert the tristimulus values into chromaticity coordinates. According to the equation (2), the tristimulus values are converted into chromaticity coordinates that can be represented by the following equations:

| chromaticity coordinates | | |
|---|---|---|
| displaying | displaying | displaying |
| red | green | blue |

| light sources | x | y | x | y | x | Y |
|---|---|---|---|---|---|---|
| a plurality | xR | yR | xG | yG | xB | yB |
| of LEDs | | | | | | |

$$xR = \frac{XRR}{XRR + YRG + ZRB} , yR = \frac{YRG}{XRR + YRG + ZRB} \\ xG = \frac{XGR}{XGR + YGG + ZGB} , yG = \frac{YGG}{XGR + YGG + ZGB} \\ xB = \frac{XBR}{XBR + YBG + ZBB} , yB = \frac{YBG}{XBR + YBG + ZBB} \qquad ( 4 )$$

The fifth step is calculated the proportion relationship of the numbers of a:b:c via substituting the chromaticity coordinates of the chromaticity system into equation (4).

The red, green, and blue LEDs 215, 216, 217 with pre-determined numbers should enable the light beams emitted by the backlight module 21 match with the requirements of displaying red, green, blue or others colored images on the LCD panel 20. Therefore, the chromaticity coordinates of the chromaticity system and the equation (3) are substituted into the equation (4), to obtain a linear homogeneous equation relative to the values of “a”, “b”, and “c”. Due to the linear homogeneous equation has no unique solution, whereby it only can confirm the proportion relationship between the values of “a”, “b”, and “c”, i.e., a:b:c=A:B:C. That is, the values of the “a”, “b”, and “c” satisfied the relationship of a:b:c=A:B:C may match with the requirements of ensure the LCD panel 20 to display desired red, green, blue and others color images.

Maybe the values of A, B, C are not integers, then the values of “a”, “b”, and “c” may select a set of integers to enable the ratio of a:b:c approximate to A:B:C in a permissible error. Moreover, the values of A, B, C may be very large, whereby the selected integers should match with the practical situations of the LCD panel 20.

For example, the proportion of a:b:c may be set as 1:2:1, and the red, green, and blue LEDs 215, 216, 217 may alternatively arranged to ensure the red, green, and blue light beams sufficiently mixing.

The backlight module 21 of the LCD device 2 includes a driving circuit 211 and an LED array 214, whereby the numbers of the red, green, and blue LEDs 215, 216, 217 of the LED array 214 are pre-confirmed, to enable the driving circuit 211 to provide the driving voltages to the LEDs 215, 216, 217 via only a terminal 212. Compared with the related art, the driving circuit 211 omits two terminals for driving LEDs, which lower the cost and simplified the structure.

Referring to FIG. 4, a circuit diagram of a backlight module installed in an LCD device according to a second embodiment of the present invention is shown. The backlight module 31 has a structure similar to that of the backlight module 21. However, the backlight module 31 includes a micro modulating unit 313. The driving circuit 311 of the backlight module 31 includes a second terminal 310 for providing driving voltages to the micro modulating unit 313. The micro modulating unit 313 includes a red LED 318 and a green LED 319 electrically connected to the second terminal 310 in series.

The second terminal 310 provides driving voltages to the red LED 318 and the green LED 319, whereby the driving voltages output from the second terminal 310 is lower than the driving voltages output from the first terminal 312. Therefore, the red and green LEDs 318, 319 are operated in a power lower than the LEDs of the LED array 314.

In operation, the LED array 314 cooperatively with micro modulating unit 313 may generate light beams more approximate to ideal values.

Various modifications and alterations are possible within the ambit of the invention herein. For example, the micro modulating unit may includes at least one of the red, green, and blue LEDs. Moreover, the second terminal may provide driving voltages higher than the driving voltages provided by the first terminal.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A liquid crystal display device, comprising:
a liquid crystal display panel; and
a backlight module comprising a driving circuit and a light emitting diode array, the driving circuit comprising a first terminal, and the light emitting diode array comprising a plurality of red, green, and blue light emitting diodes connected in series;
wherein a number of the red light emitting diodes is “a”, a number of the green light emitting diodes is “b”, and a number of the blue light emitting diodes is “c”, numbers of “a”, “b”, and “c” are determined according to a predetermined color coordinate of the liquid crystal panel; the driving circuit drives the red, green, and blue light emitting diodes via the first terminal, to enable the red, green, and blue light emitting diodes to emit light beams for illuminating the liquid crystal display panel.

2. The liquid crystal display device as claimed in claim 1, wherein the driving circuit comprises a micro modulating unit and a second terminal, and the driving circuit drives the slightly modulating unit via the second terminal.

3. The liquid crystal display device as claimed in claim 2, wherein the micro modulating unit comprises at least one of the red, green, and blue light emitting diodes.

4. The liquid crystal display device as claimed in claim 1, wherein a spectrum of the red light emitting diodes is S(R), a spectrum of the green light emitting diodes is S(G), and a spectrum of the blue light emitting diodes is S(B); the liquid crystal display panel has a penetration spectrum of τ_{R}(λ) while displaying red images, a penetration spectrum of τ_{G}(λ) while displaying green images, and a penetration spectrum of τ_{B}(λ) while displaying blue images; the liquid crystal panel has chromaticity coordinates of (xR, yR) while displaying red images, chromaticity coordinates of (xG, yG) while displaying green images, and chromaticity coordinates of (xB, yB) while displaying blue images; spectral tristimulus values are x̅(λ), y̅(λ), z̅(λ); and “A”, “B”, and “C” represent unknown number, and A:B:C is determined by the following equation:
$$\{ \begin{matrix}Xi n = S ( n ) {τ}_{n} ( λ ) \overline{x} ( λ ) & & & \\ Yi n = S ( n ) {τ}_{n} ( λ ) \overline{y} ( λ ) & & & \\ Zi n = S ( n ) {τ}_{n} ( λ ) \overline{z} ( λ ) & i = 1 , 2 , 3 & n = R , G , B & \end{matrix} \\ XRR = ( A , B , C ) \cdot [ \begin{matrix}X 1 R \\ X 2 R \\ X 3 R\end{matrix} ] XGR = ( A , B , C ) \cdot [ \begin{matrix}X 1 G \\ X 2 G \\ X 3 G\end{matrix} ] \\ XBR = ( A , B , C ) \cdot [ \begin{matrix}X 1 B \\ X 2 B \\ X 3 B\end{matrix} ] YRG = ( A , B , C ) \cdot [ \begin{matrix}Y 1 R \\ Y 2 R \\ Y 3 R\end{matrix} ] \\ YGG = ( A , B , C ) \cdot [ \begin{matrix}Y 1 G \\ Y 2 G \\ Y 3 G\end{matrix} ] YBG = ( A , B , C ) \cdot [ \begin{matrix}Y 1 B \\ Y 2 B \\ Y 3 B\end{matrix} ] \\ ZRB = ( A , B , C ) \cdot [ \begin{matrix}Z 1 R \\ Z 2 R \\ Z 3 R\end{matrix} ] ZGB = ( A , B , C ) \cdot [ \begin{matrix}Z 1 G \\ Z 2 G \\ Z 3 G\end{matrix} ] \\ ZBB = ( A , B , C ) \cdot [ \begin{matrix}Z 1 B \\ Z 2 B \\ Z 3 B\end{matrix} ] \\ xR = \frac{XRR}{XRR + YRG + ZRB} , \\ yR = \frac{YRG}{XRR + YRG + ZRB} \\ xG = \frac{XGR}{XGR + YGG + ZGB} , yG = \frac{YGG}{XGR + YGG + ZGB} \\ xB = \frac{XBR}{XBR + YBG + ZBB} , yB = \frac{YBG}{XBR + YBG + ZBB}$$
the numbers “a”, “b”, and “c” are the integer solution of the value of A:B:C in a permissible error.

5. The liquid crystal display device as claimed in claim 4, wherein chromaticity coordinates and spectral tristimulus values are defined according to the standard colorimeter system of 1931CIE-XYZ.

6. The liquid crystal display device as claimed in claim 4, wherein the value of A:B:C is set as 1:2:1 via modulating the spectrum of the red, green, and blue light emitting diodes.

7. The liquid crystal display device as claimed in claim 4, wherein the liquid crystal panel has a multi-layer structure, a penetration spectrum of the liquid crystal panel is a product of each of the penetration spectrums of each layer structure thereof.

8. The liquid crystal display device as claimed in claim 7, wherein the liquid crystal panel comprises a color filter layer, the color filter layer comprises a plurality of red color units with a penetration spectrum of τ_{1R}(λ), a plurality of red color units with a penetration spectrum of τ_{1G}(λ), and a plurality of red color units with a penetration spectrum of τ_{1B}(λ), a product of penetration spectrums of other layers of the liquid crystal display panel is Πτᵢ(λ), then the τ_{R}(λ), τ_{G}(λ), and τ_{B}(λ) is illustrated by the following equation:
τ_{R}(λ)=τ_{1R}(λ)Πτᵢ(λ),
τ_{G}(λ)=τ_{1G}(λ)Πτᵢ(λ),
τ_{B}(λ)=τ_{1B}(λ)Πτᵢ(λ).

9. The liquid crystal display device as claimed in claim 8, wherein the other layers of the liquid crystal panel comprises a first polarizer, a second polarizer, a liquid crystal layer, a first alignment film, a second alignment film.

10. The liquid crystal display device as claimed in claim 9, wherein the other layers of the liquid crystal panel further comprises a common electrode and a pixel electrode.

11. The liquid crystal display device as claimed in claim 1, wherein the first terminal outputs a driving voltage higher than that outputted by the second terminal.
